(19) United States
(12) Patent Application Publication
(10) Pub. No.: US 2013/0015141 A1
(43) Pub. Date: Jan. 17, 2013

(54) NOVEL INJECTION FLOCCULATION AND COMPRESSION DEWATERING UNIT FOR SOLIDS CONTROL AND MANAGEMENT OF DRILLING FLUIDS AND METHODS RELATING THERETO

(71) Applicants: Charles R. Landis, The Woodlands, TX (US); Ryan P. Collins, Spring, TX (US); Edward A. Anderson, Spring, TX (US); Roger H. Woods, Watford (CA); Douglas G. Pullman, Watford (CA); David M. Donald, Houston, TX (US)

(72) Inventors: Charles R. Landis, The Woodlands, TX (US); Ryan P. Collins, Spring, TX (US); Edward A. Anderson, Spring, TX (US); Roger H. Woods, Watford (CA); Douglas G. Pullman, Watford (CA); David M. Donald, Houston, TX (US)

(21) Appl. No.: 13/180,224

(22) Filed: Jul. 11, 2011

(51) Int. Cl. B01D 21/01; B01D 25/12

(52) U.S. Cl. 210/710; 210/712

(57) ABSTRACT

A method may include providing a returned fluid comprising a fluid; and a solid contaminant; introducing the returned fluid into a solid-liquid sorter thereby separating the returned fluid into an overflow and underflow; flocculating the underflow in a flocculating chamber thereby forming a flocculated fluid; and dewatering the flocculated fluid using a dewatering rack.

### CROSS-REFERENCE TO RELATED APPLICATIONS

The present invention is related to co-pending U.S. application Ser. No. ______ [Attorney Docket No. HES 2011-IP-046463U1] entitled “NOVEL INJECTION FLOCCULATION AND COMPRESSION DEWATERING UNIT FOR SOLIDS CONTROL AND MANAGEMENT OF DRILLING FLUIDS AND METHODS RELATING THERETO,” filed concurrently herewith, the entire disclosure of which is hereby incorporated by reference.

### BACKGROUND

The present invention relates to flocculation and dewatering systems for separating solid-liquid mixtures. More particularly, the present invention relates to flocculation and dewatering systems for recycling and reconditioning subterranean treatment fluids and methods of use thereof,

Subterranean operations such as drilling, mineral exploring and geological coring often require fluids that are introduced into the subterranean environment for the completion of desired tasks. For example, drilling fluids, also commonly referred to as drilling muds, are used in most modern drilling operations. In a drilling operation, a drilling fluid provides a number of important functions, which includes preventing formation fluids from entering the wellbore, carrying out drill cuttings, suspending drill cuttings while drilling is paused, and keeping the drill bit cool and clean. Overall, drilling fluids provide stability to a wellbore during a drilling operation. Some fluids are referred to as “drill-in fluids.” Drill-in fluids are specialty drilling fluids designed for drilling through the reservoir section of a wellbore. The reasons for using a specially designed mud are: (1) to drill the reservoir zone successfully, often a long, horizontal drainhole; (2) to minimize damage and maximize production of exposed zones; and (3) to facilitate the well completion needed, which can include complicated procedures. Drill-in fluids are often brines comprising only solids of appropriate particle size ranges such as salt crystals or calcium carbonate and polymers. Generally, only additives essential for filtration control and cuttings carrying are present in a drill-in fluid. The term drilling fluids as used herein includes drill-in fluids.

There are many different types of drilling fluids including water-based, oil-based, polymer-based, clay-based, and synthetic-based fluids. While the composition may vary, a drilling fluid is generally composed of a fluid (liquid or gas) and may further comprise various additives including, but not limited to, polymers, salts, clays, and viscosifiers. The exact composition of a drilling fluid may be engineered to meet the specific needs of a drilling operation based on factors such as rock formation, type of petroleum being recovered, environmental concerns, and the like. A drilling fluid is usually homogeneous and mixed prior to circulation in a subterranean environment. However, once a drilling fluid is introduced to a wellbore, its composition can change drastically. For example, drill cuttings such as rocks, sand, shale, grit, and other contaminants can become suspended and mixed in the drilling fluid during a drilling operation. These solids inevitably make their way up as part of returned fluids as the drilling fluid is returned to the surface.

While drilling fluids provide numerous advantages, there are several drawbacks. For example, drilling fluids can be very costly and, while the exact cost depends on the operation, can take up a significant portion of the total cost of drilling a well. Moreover, the long term effects that drilling fluids have on the environment may be uncertain. These important considerations have spurred efforts to recondition returned drilling fluids so that the drilling fluids may be recycled and reintroduced in a wellbore.

In conventional drilling operations, the drilling fluids are recirculated after removing the drilling cutting and other solid contaminants from the fluid. This recycling and reconditioning process generally involves recovering the returned drilling fluid at the surface, removing drilling cuttings and undesirable drill solids, and recirculating the reconditioned drilling fluid into the well. The removal or separation of solids from the drilling fluids is typically done using a size exclusion screen. Smaller solids may further be removed, at least partially, by additional processing equipments such as a hydrocyclone or centrifuges. A hydrocyclone or a centrifuge separate suspensions by density and generate two types of fluids, an overflow and an underflow. The composition of the overflow is the same or very similar to a new drilling fluid and may be reintroduced into the wellbore without further treatment. On the other hand, the underflow is a concentrated fluid comprising much of the unwanted solids present in the returned fluid.

There are, however, limitations on current separation techniques. For example, in a typical recycling and reconditioning process, only about 50-80% of the returned fluid may be separated into overflow. This means that a significant volume of underflow is left over. Because this underflow typically needs further treatment before it can be disposed or reused, there are considerable cost and time considerations.

### SUMMARY OF THE INVENTION

The present invention relates to flocculation and dewatering systems for separating solid-liquid mixtures. More particularly, the present invention relates to flocculation and dewatering systems for recycling and reconditioning well treatment fluids and methods of use thereof,

In one embodiment, a method comprises: providing a returned fluid comprising: a fluid; and a solid contaminant; introducing the returned fluid into a solid-liquid sorter thereby separating the returned fluid into an overflow and underflow; flocculating the underflow in a flocculating chamber thereby forming a flocculated fluid; and dewatering the flocculated fluid using a dewatering rack.

In one embodiment, a method comprises: providing a returned fluid comprising: a drilling fluid wherein the drilling fluid has been circulated in a subterranean environment; flowing the returned fluid through a hydrocyclone thereby separating the returned fluid into an overflow and an underflow; flocculating the underflow in a flocculation chamber thereby forming a flocculated fluid; dewatering the undertow in a dewatering rack; and introducing the overflow into a mixing unit comprising: a basin.

In one embodiment, a method comprises: providing a returned fluid comprising: a drilling fluid wherein the drilling fluid has been circulated in a subterranean environment; flowing the returned fluid through a hydrocyclone thereby separating the returned fluid into an overflow comprising reusable drilling fluid and an underflow comprising solid contaminants; introducing the underflow in a flocculation chamber comprising: a trough comprising an injection port for introducing a flocculant, thereby forming a flocculated fluid; and introducing the flocculated fluid to a dewatering rack comprising: at least one filtration collection bag situated in at least one collection basket; and a filter press; and dewatering the underflow by pressing the filtration collection bag with the filter press.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIG. 1A-1B are schematic diagrams of a flocculation and dewatering system. FIG. 1A is an embodiment of a flocculation and dewatering system in reconditioning mode. FIG. 1B is an embodiment of a flocculation and dewatering system in mixing mode.

FIG. 2 is a close-up schematic diagram of an embodiment of a flocculation chamber and a dewatering rack.

FIG. 3A-3C are schematic diagrams of the different positions of a multi-position lever system of a filter press.

### DETAILED DESCRIPTION

The present invention relates to flocculation and dewatering systems for separating solid-liquid mixtures. More particularly, the present invention relates to flocculation and dewatering systems for recycling and reconditioning well treatment fluids and methods of use thereof,

The present invention provides systems and methods for recycling and reconditioning returned fluids. As used herein, “returned fluid” generally refers to a treatment fluid that has been introduced to a subterranean environment and that has been circulated back up to the surface. Suitable examples of returned fluids for use in conjunction with the present invention include, but are not limited to, drilling fluids, completion fluids, and combinations thereof. Fluids suitable for use in conjunction with the present invention may be water-based, oil-based, polymer-based, clay-based (e.g., bentontite), synthetic-based, and the like,

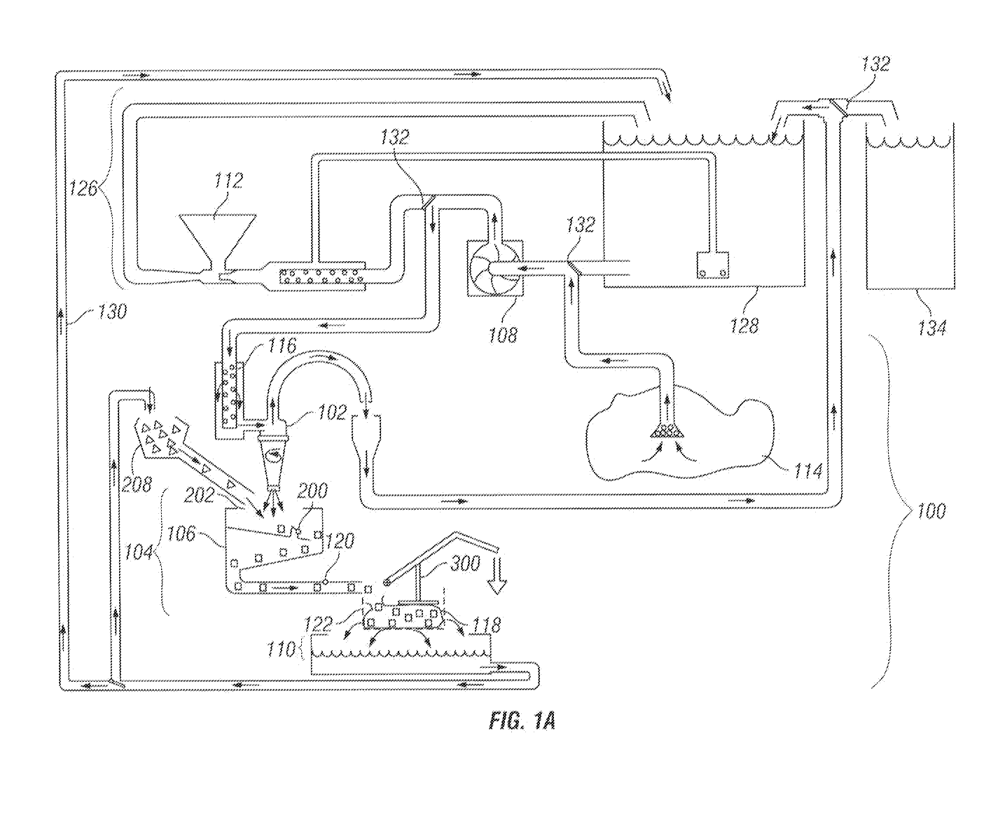

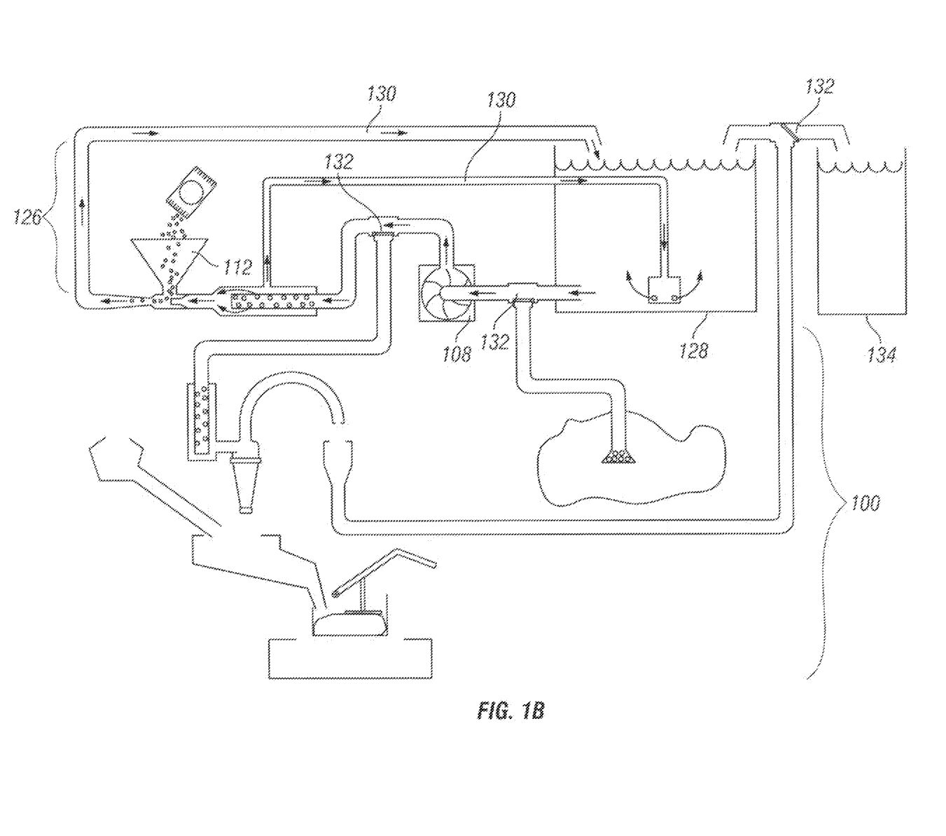

In particular, an example of a returned fluid may be a drilling fluid that has been used in a drilling operation and that includes various solid contaminants such as drill cuttings, rocks, sand, shale, grit, assorted debris, and other solid contaminants. As shown in FIG. 1, the flocculation and dewatering system 100 of the present invention provides elements, such as, solid-liquid sorter 102, flocculation chamber 104, dewatering rack 110, etc., that may be used individually or in tandem to recondition returned fluids thereby forming a reconditioned fluid which may be recycled by being reused. The flocculation and dewatering system 100 of the present invention may also be used to mix various fluids and starting materials to provide treatment fluids which may be introduced into a subterranean environment. The elements may be modular in nature and may be rearranged and/or reconfigured as desired. The reconditioned fluids may be reused by being reintroduced into a subterranean environment thereby minimizing generated chemical wastes.

It is believed that the present invention provides superior separation of solid-liquid mixtures compared to typical separation systems and techniques. Specifically, it is believed that the present invention would provide a higher ratio of overflow to underflow as compared to typical separation systems and methods. As used herein, “overflow” refers to a separated portion of a returned fluid that may be reused and recycled. As used herein, “underflow” refers to a separated portion of a returned fluid that requires reconditioning to recover reusable and recyclable portions of a treatment fluid. Typically, the overflow may be reused without further reconditioning. The underflow generally comprises solid contaminants such as those accumulated while a returned fluid is circulating in a subterranean environment. In a drilling operation, solid contaminants may be drill cuttings, rocks, sand, shale, grit, assorted debris, and other solid contaminants which can become suspended and mixed in the drilling fluid during a drilling operation. In some embodiments, the overflow comprises reusable treatment fluids which may be introduced into the mixing unit 126. Moreover, the present invention is able to recondition the underflow so that a large portion is reusable in a subterranean operation and thus recyclable. The solid contaminants which are separated are typically not reusable. It is also believed that the present invention provides superior efficiency in the reconditioning of the underflow as compared to typical separation systems and techniques. This superior efficiency is in part related to the superior mixing and flocculating characteristics of the flocculating chamber 104, in particular, the flocculating trough 106. It is believed that the geometry (e.g., the slope of the trough) of the flocculating trough 106 unexpectedly enhances the mixing and flocculation of the underflow. This ability to recondition returned fluids for subsequent reuse in subterranean operations enables the operator to save considerable costs.

Another advantage of the present invention is that the elements of the flocculation and dewatering system 100 have been configured (e.g., geometrically, volumetrically, etc.) and optimized to ease the handling of large amounts of returned fluids. Yet another advantage is that some or all of the elements of the present invention have been designed to be portable. The present invention also provides a single system which is able to function in two separate modes: reconditioning mode (FIG. 1A) and mixing mode (FIG. 1B). This dual functionality provides added convenience and saves considerable cost. This may be particularly important if the particular flocculation and dewatering operation is located in a remote or hard to reach location.

To facilitate a better understanding of the present invention, the following examples of preferred embodiments are given. In no way should the following examples be read to limit, or to define, the scope of the invention.

FIG. 1A shows a schematic diagram representing one embodiment of the present invention. Referring to FIG. 1A, the flocculation and dewatering system 100 of the present invention generally comprises a solid-liquid sorter 102, a flocculation chamber 104, a pump 108, and a dewatering rack 110. The flocculation chamber generally comprise a flocculation trough 106. Optionally, the flocculation and dewatering system 100 may comprise a mixing unit 126 comprising a basin 128 for reintroducing overflow or reconditioned fluid. FIGS. 1A-1B also show various elements of the present invention, including dewatering rack 110, hopper 112, pit/sump 114, filter 116, filtration collection bag 118, outlet 120, collection basket 122, filter press 124, mixing unit 126, basin 128, conduit network 130, two-way valve 132, active tank 134, baffle 200, injection port 202, flocculant dispenser 208, and lever system 300. The elements of the present invention will be described below.

In some embodiments, the solid-liquid sorter 102 may sort a solid-liquid mixture such as a suspension by density using centrifugal force. For example, a solid-liquid sorter 102 will separate a returned fluid such as a drilling fluid which has been circulated in a subterranean environment into a relatively lower density fluid (overflow) comprising relatively fewer solid contaminants and a relatively higher density fluid (undertow) comprising relatively more solid contaminants. Suitable examples of solid-liquid sorter 102 include, but are not limited to, centrifuges, shaker beds, helix tubular sorters, counterspinning screens, vibrating beds, filter boxes and/or hydrocyclones.

In the embodiment shown in FIG. 1A, the returned fluid may be introduced in a solid-liquid sorter 102 in a number of ways including a conduit network 130 comprising a two-way valve 132 which controls the direction of fluid flow. In some embodiments, a plurality of one-way valves (not shown) may be used instead of two-way valves 132. The conduit network 130 at least partially runs through the flocculation and dewatering system 100 thereby providing a fluidic connection between the elements. In some embodiments, there may be a plurality of two-way valves 132 to form a two-way valve system. In some embodiments, the conduit network 130 is connected to the basin 128 of a mixing unit 126. In some embodiments, a basin 128 may be connected to an active tank 134. In some embodiments, an active tank 134 may be used as a reservoir to store the overflow and/or reconditioned fluids. In some embodiments, an active tank 134 may introduce fluids (e.g., overflow, recondition fluid, etc.) to a basin 128 which then acts as a reservoir for mixing fluids.

Referring to FIGS. 1A-1B, the basin 128 may be used to mix various components, including the starting materials of a treatment fluid and the reconditioned fluid. In some embodiments, the flocculation and dewatering system 100 may switch between a mixing mode wherein the primary function is to prepare a treatment fluid to a reconditioning mode wherein the primary function is to recondition a returned fluid for subsequent use in a subterranean application. A switch between the modes can be quickly and efficiently performed in the field, without having to relocate or reconfigure the flocculation and dewatering system 100.

FIG. 1A is a schematic diagram of the flocculation and dewatering system 100 in a typical reconditioning mode. In the embodiment shown in FIG. 1A, multiple two-way valves 132 are positioned so that returned fluid may be drawn from a pit or sump 114 through a conduit network 130 by a pump 108. The returned fluid may pass through an optional filter 116 in order to remove solids that are above the maximum size tolerated by the flocculation and dewatering system 100. Suitable examples of a filter 116 include a cylindrical sleeve and/or tube having openings in the periphery so that fluid may enter axially at one end and exit radially through the peripheral openings. Eventually, the returned fluid is introduced into solid-liquid sorter 102 for flocculation and later dewatered in a dewatering rack 110. The conduit network 130 may also be used to transfer the removed water from the dewatering rack 110 to other elements of the flocculation and dewatering system 100.

FIG. 1B is a schematic diagram of the flocculation and dewatering system 100 in a typical mixing mode. The elements of the flocculation and dewatering system 100 are modular and may be rearranged and/or reconfigured as desired. In the mixing mode, the flocculation and dewatering system 100 is generally configured similar to U.S. Pat. No. 5,779,355, which is herein incorporated by reference. Generally, while in the mixing mode, the flocculation chamber 104 and the dewatering rack 110 are not actively used,

Generally, as shown in FIGS. 1A-1B, a pump 108 may be used to transfer fluids through the conduit network 130. Suitable examples of a pump include piston pumps, screw type pumps, diaphragm pumps, positive displacement pumps, and centrifugal pumps. In some embodiments, the pump 108 is rated between about 5 horsepowers to about 25 horsepowers. In some embodiments, the pump 108 weighs less than about 1000 pounds. The pump 108 is useful for transferring fluids from one element (e.g., mixing unit 126, solid-liquid sorter 102, etc.) of the flocculation and dewatering system 100 to another element (e.g., solid-liquid sorter 102, flocculation chamber 104, etc.) of the flocculation and dewatering system 100. Depending on desirability, the pump 108 may be installed anywhere within the flocculation and dewatering system 100. In some embodiments, a plurality of pumps may be used.

Referring to FIG. 1A, the solid-liquid sorter 102 is generally configured to transfer the underflow to the flocculation chamber 104 by a pump 108 or by other suitable techniques such as by gravity and the like. Where desirable, the solid-liquid sorter 102 will be configured to conveniently transfer the overflow to a mixing unit 126 comprising a basin 128 through the conduit network 130. In some embodiments, the mixing unit 126 may have several functions including, but not limited to, mixing the overflow with unused treatment fluids and reintroducing the mixture into a subterranean environment. The mixing unit 126 may also comprise a hopper 112 for introducing dry reagent products which is later mixed in with the treatment fluid. In some embodiments, the subterranean environment may be a wellbore for oil drilling, geological coring, mineral exploring and the like.

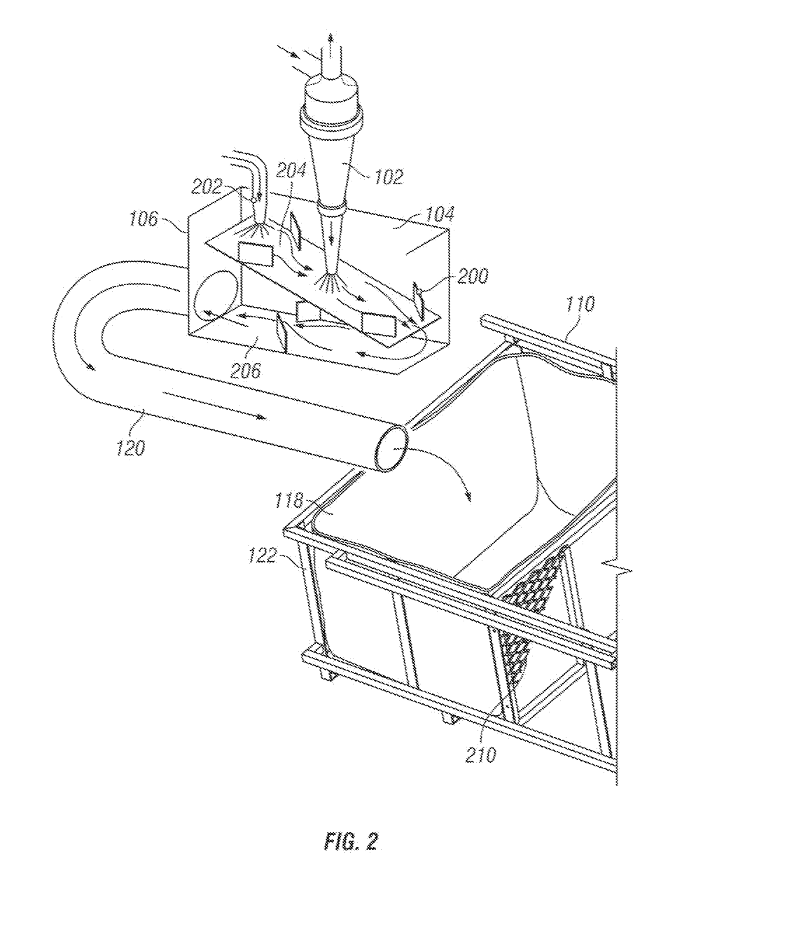

FIG. 2 is a close-up schematic showing the solid-liquid sorter 102, flocculation chamber 104 and the dewatering rack 110. In the embodiment shown in FIG. 2, the solid-liquid sorter 102 is a hydrocyclone. Referring to FIG. 2, the flocculation chamber 104 generally comprises a flocculation trough 106 which comprises at least one baffle 200 and an injection port 202 for introducing a flocculant and an outlet 120 for removing a flocculated fluid. The outlet 120 is used to transfer a flocculated fluid from the flocculation chamber 104 to the dewatering rack 110.

Referring to FIG. 2, in some embodiments, a hydrocyclone will comprise a conical base wherein the top size of the conical base is about 2 inches to about 4 inches in diameter. In some embodiments, the top size of the conical base is about 1 inch to about 2 inches in diameter. The top size of the conical base determines the size or range of sizes of particles which may be separated. Generally, a larger top size will separate relatively larger solids while a smaller top size will separate relatively smaller solids. It is believed that a top size of about 2 inches to 4 inches in diameter will separate approximately 15-30 micron solids. In some embodiments, a plurality of hydrocyclones may be used to separate a multiple range of solid sizes. The plurality of hydrocyclones may be used sequentially or in replacement.

Referring to FIG. 2, in some embodiments, the injection port 202 is connected to a flocculant dispenser 208 (shown in FIG. 1A) which can introduce wet or dry flocculants into the flocculation chamber 104. The mixing of the flocculant with the underflow forms a flocculated fluid. Suitable examples of flocculants include, but are not limited to, alum, polyacrylamide, partially-hydrolyzed polyacrylamide (PHPA), chitosan, guar, and gelatin.

Referring to FIG. 2, in some embodiments, the flocculation trough 106 may be partitioned to divide the flocculation chamber 104 into an upper flocculation chamber 204 and a lower flocculation chamber 206. In some cases, the partition is created by having a flocculation trough 106 having a slope of about 1 degree to about 46 degrees as measured from the bottom of the flocculation chamber 104. The sloped flocculation trough 106 comprises the upper flocculation chamber 204 while the bottom portion of the flocculation chamber 104 comprises the lower flocculation chamber 206. In some embodiments, the lower flocculation chamber 206 may comprise an outlet 120 for transferring the flocculated fluid out of the flocculation chamber 104. The partitioning of the flocculation chamber 104 into an upper flocculation chamber 204 and a lower flocculation chamber 206 may enhance mixing of the flocculant with the underflow thereby enhancing the flocculation of the underflow for several reasons. Without being limited by theory, it is believed that the baffle 200 and the slope of the flocculation trough 106 will facilitate the mixing of the returned fluid and the flocculant. The partition lengthens the duration of mixing as the fluids must travel a farther distance before exiting the flocculation chamber 104. It is also believed that mixing and flocculating is further enhanced by the impact created as the returned fluid is introduced into the flocculation chamber 104 and crashes into the flocculation trough 106. This was an unexpected result confirmed by visual inspection. Once the flocculant is introduced into the flocculation trough 106 and mixed with the underflow, a flocculated fluid will form. In some embodiments, the dimensions of the flocculation trough 106 is about 24 inches to about 48 inches in length, about 6.5 inches to about 18 inches in width, and about 10 inches to 24 inches in height,

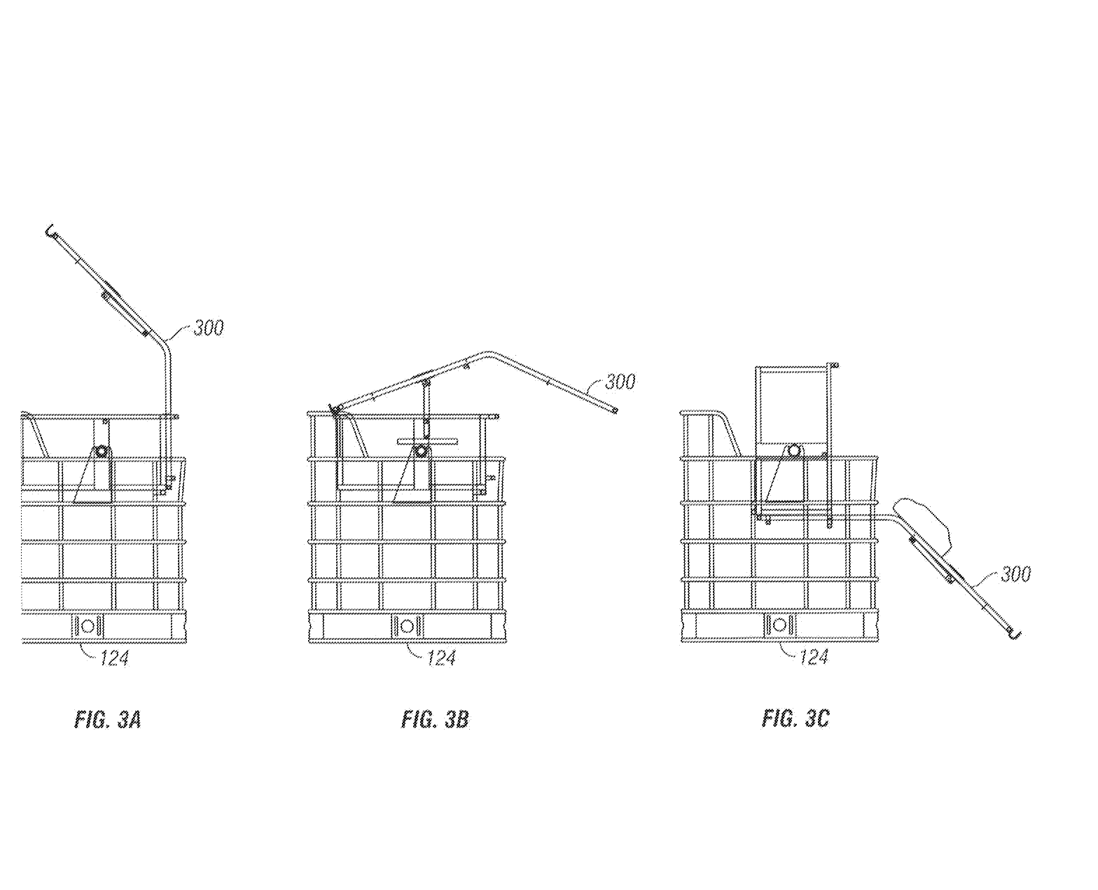

Referring again to FIG. 2, the dewatering rack 110 generally comprise at least one filtration collection bag 118; and a filter press 124. In some embodiments, the filtration collection bag 118 may be a weeping bag. In some embodiments, the filtration collection bag 118 may be placed in a collection basket 122 or on the ground. The collection basket 122 may be configured to allow fluids to pass through. For example, the collection basket 122 may comprise meshes 210, pores, or be generally permeable. In some embodiments, the filtration collection bag 118 may be made from woven felt, non-woven felt, or a combination of both. The filtration collection bag 118 may hold about 10 gallons to about 100 gallons of flocculated fluid. In some embodiments, there may be more than one filtration collection bag 118. Once the filtration collection bag 118 is filled with a flocculated fluid, a filter press 124 (shown in FIG. 3A-3C) may be used to remove water from the flocculated fluid to form a dewatered flocculated fluid. Referring to Figure IA, in some embodiments, the removed water may then be introduced into the mixing unit 126 or into the flocculant dispenser 208.

FIGS. 3A-3C show the filter press 124 with a lever system 300. Referring to FIGS. 3A-3C, the filter press 124 is generally configured to engage the filtration collection bag 118 and dewater the flocculated fluid. In some embodiments, the filter press 124 may be activated manually as by a lever system 300. As shown in FIGS. 3A-3C, the lever system 300 may be a multi-position lever system. FIG. 3A shows the filter press 124 in an uncompressed state. FIG. 3B shows the filter press 124 in a semi-compressed state. FIG. 3C shows the filter press 124 in a fully compressed state. In some embodiments, the filter press 124 may dewater the flocculated fluid hydraulically, pneumatically, or both.

The methods of the present invention generally comprise providing a returned fluid comprising a fluid; and a solid contaminant; introducing the returned fluid into a solid-liquid sorter thereby separating the returned fluid into an overflow and an underflow; flocculating the underflow in a flocculating chamber 104 thereby forming a flocculated fluid; and dewatering the flocculated fluid using a dewatering rack 110.

The fluid may be a liquid or gas-based fluid. In some embodiments, the returned fluid may comprise a drilling fluid wherein the drilling fluid has been circulated in a subterranean environment. Flowing the returned fluid through a hydrocyclone may separate the returned fluid into an overflow and an underflow. The overflow may comprise reusable drilling fluid. The underflow may comprise solid contaminants. In some cases, the overflow may be introduced into a mixing unit 126 comprising a basin 128. In some embodiments, the underflow may be flocculated in a flocculation chamber 104 and dewatered in a dewatering rack 110. In some embodiments, the underflow may be dewatered by pressing the filtration collection bag 118 such as by pressing a filter press 124,

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a returned fluid comprising:
a fluid; and
a solid contaminant;
introducing the returned fluid into a solid-liquid sorter thereby separating the returned fluid into an overflow and underflow;
flocculating the underflow in a flocculating chamber thereby forming a flocculated fluid; and
dewatering the flocculated fluid using a dewatering rack.

2. The method of claim 21 wherein the returned fluid comprises a used fluid selected from the group consisting of: a drilling fluid, a completion fluid and any combination thereof.

3. The method of claim 21 wherein the fluid is gas or liquid.

4. The method of claim 21 wherein the solid contaminant comprises one selected from the group consisting of: a drilling cutting, a rock, sand, a shale debris, a grit, assorted debris, and any combination thereof.

5. The method of claim 21 wherein the solid-liquid sorter is a centrifuge, a shaker bed, a helix tubular sorter, a counterspinning screen, a vibrating bed, a filter box, or a hydrocyclone.

6. The method of claim 25 wherein the hydrocyclone comprises a conical base wherein the top size of the conical base is between about 2 to 4 inches in diameter.

7. The method of claim 21 wherein the flocculated fluid is formed by a flocculant comprising one selected from the group consisting of: alum, polyacrylamide, partially-hydrolyzed polyacrylamide (PHPA), chitosan, guar, and gelatin.

8. A method comprising:
providing a returned fluid comprising:
a drilling fluid wherein the drilling fluid has been circulated in a subterranean environment;
flowing the returned fluid through a hydrocyclone thereby separating the returned fluid into an overflow and an underflow;
flocculating the underflow in a flocculation chamber thereby forming a flocculated fluid;
dewatering the underflow in a dewatering rack; and
introducing the overflow into a mixing unit comprising: a basin.

9. The method of claim 28 wherein the subterranean environment is a wellbore.

10. The method of claim 28 wherein the flocculation chamber comprises:
a flocculation trough comprising:
at least one baffle;
an injection port for introducing a flocculant; and
an outlet for removing the flocculated fluid.

11. The method of claim 28 wherein the dewatering rack comprises:
at least one filtration collection bag situated in at least one collection basket; and
a filter press.

12. The method of claim 31 wherein the filter press is activated manually by a lever system.

13. The method of claim 31 wherein the filter press removes water from the filtration collection bag by compressing hydraulically, pneumatically, or both.

14. A method comprising:
providing a returned fluid comprising:
a drilling fluid wherein the drilling fluid has been circulated in a subterranean environment;
flowing the returned fluid through a hydrocyclone thereby separating the returned fluid into an overflow comprising reusable drilling fluid and an underflow comprising solid contaminants;
introducing the underflow in a flocculation chamber comprising:
a trough comprising an injection port for introducing a flocculant, thereby forming a flocculated fluid; and
introducing the flocculated fluid to a dewatering rack comprising:
at least one filtration collection bag situated in at least one collection basket; and
a filter press; and
dewatering the underfloor by pressing the filtration collection bag with the filter press,

15. The method of claim 34 wherein the solid contaminants comprise one selected from the group consisting of: a drilling cutting, a rock, sand, a shale debris, a grit, assorted debris, and any combination thereof.

16. The method of claim 34 wherein the flocculant comprises one selected from the group consisting of: alum, polyacrylamide, partially-hydrolyzed polyacrylamide (PHPA), chitosan, guar, and gelatin.

17. The method of claim 34 wherein the dewatering rack comprises two filtration collection bags.

18. The method of claim 34 wherein the dewatering is achieved by pressing the filter press manually,

19. The method of claim 38 wherein the dewatering is achieved by pressing the filter press by a lever system.

20. The method of claim 34 wherein the flocculation trough is about 24 inches to about 48 inches in length, about 6.5 inches to about 18 inches in width, and about 10 inches to 24 inches in height.
